(19) United States
(12) Patent Application Publication
(10) Pub. No.: US 2017/0193290 A1
(43) Pub. Date: Jul. 6, 2017

(54) COMMODITY REGISTRATION APPARATUS AND COMMODITY REGISTRATION METHOD

(71) Applicant: TOSHIBA TEC KABUSHIKI KAISHA, Tokyo (JP)

(72) Inventor: Masaaki Yasunaga, Sunto Shizuoka (JP)

(21) Appl. No.: 14/989,265

(22) Filed: Jan. 6, 2016

(51) Int. Cl. G06K 9/00; G06T 7/00; G06K 9/62

(52) U.S. Cl. CPC G06K 9/00355; G06K 9/6201; G06T 7/004; G06T 7/0079; G06T 7/0024; G06T 2207/30196; G06T 2207/20144

(57) ABSTRACT

According to an embodiment, a commodity registration apparatus includes an interface and a processor. The interface is configured to acquire an image on which a commodity appears. The processor is configured to, extract a hand/arm area which is an image area of a part of a person in the image, output an alert when the hand/arm area was extracted, register, as a dictionary, the image acquired by the interface, when the hand/arm area is not extracted.

### FIELD

Embodiments described herein relate generally to a commodity registration apparatus and a commodity registration method.

### BACKGROUND

A commodity registration apparatus, which recognizes a commodity (target) appearing on an image, has been put to practical use. The commodity registration apparatus acquires an image of a commodity by a camera, and compares the acquired image and an image of each of pre-registered commodities, thereby recognizing the commodity appearing on the image.

In order to operate the commodity registration apparatus, it is necessary to pre-register images of commodities that are to be recognized. Thus, in some cases, it is time-consuming to register many commodities.

### BRIEF DESCRIPTION OF THE DRAWINGS

FIG. 1 is an explanatory view for describing a configuration example of a commodity registration apparatus according to an embodiment, and the arrangement of respective structural parts.

FIG. 2 is an explanatory view for describing a configuration example of the commodity registration apparatus according to the embodiment.

FIG. 3 is an explanatory view for describing an operation of a commodity registration apparatus 1 according to a first embodiment.

FIG. 4 is an explanatory view for describing an operation of a commodity registration apparatus 1 according to a second embodiment.

FIG. 5 is an explanatory view for describing an operation of a commodity registration apparatus 1 according to a third embodiment.

FIG. 6 is an explanatory view for describing an operation of a commodity registration apparatus 1 according to a fourth embodiment.

FIG. 7 is an explanatory view for describing an operation of a commodity registration apparatus 1 according to a fifth embodiment.

### DETAILED DESCRIPTION

In general, according to one embodiment, a commodity registration apparatus includes an interface and a processor. The interface is configured to extract a hand/arm area which is an image area of a part of a person in an image. The processor is configured to, extract a hand/arm area which is an image area of a part of a person in the image, output an alert when the hand/arm area was extracted, register, as a dictionary, the image acquired by the interface, when the hand/arm area is not extracted.

Various embodiments will be described hereinafter with reference to the accompanying drawings.

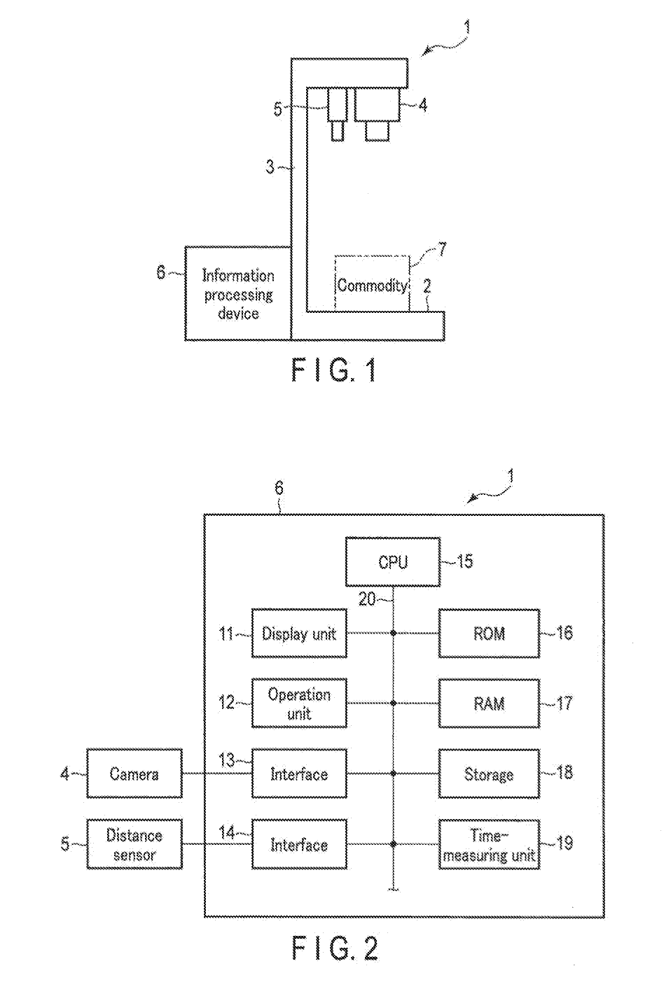

To begin with, referring to FIG. 1 and FIG. 2, the configuration of a commodity registration apparatus is described.

FIG. 1 is an explanatory view for describing the configuration of a commodity registration apparatus 1, and the arrangement of respective structural parts. FIG. 2 is an explanatory view for describing a configuration example of the commodity registration apparatus 1.

The commodity registration apparatus 1 acquires an image by photographing a commodity, and compares the acquired image and an image of each of pre-registered commodities, thereby recognizing the commodity appearing on the image. As illustrated in FIG. 1, the commodity registration apparatus 1 includes a table 2, a frame 3, a camera 4, a distance sensor 5, and an information processing device 6.

The table 2 is a flat plane for commodity disposition, on which a commodity that is a target of recognition is disposed. The table 2 is painted in a predetermined color (e.g. black).

The frame 3 is a support member for supporting the camera 4 and distance sensor 5. The frame 3 is configured such that the camera 4 and distance sensor 5 can be attached to positions facing the table 2.

The camera 4 is an imaging device for acquiring an image. The camera 4 includes an imaging element composed of a CCD (charge-coupled device) image sensor, a CMOS (complementary metal-oxide semiconductor) image sensor or some other imaging element, and a lens for forming an image of light on the imaging element. Alternatively the camera 4 is an image capturing device such as a scanner. The camera 4 is not limited to any specific type. For example, the camera 4 may be configured to photograph invisible rays. For example the camera 4 may be an infrared camera.

The camera 4 is attached to the frame 3 such that the imaging optical axis of the lens is opposed to the table 2. By this configuration, the camera 4 acquires an image of the outer appearance of the commodity 7 (an image of each face of a package of the commodity) which is disposed on the table 2. The camera 4 acquires the image at a timing corresponding to the control of the information processing device 6. In addition, the camera 4 may be configured to cyclically acquire images, that is, a moving picture.

The distance sensor 5 is a sensor which acquires a distance image. The distance image is a two-dimensional image including distances between the target and the distance sensor 5 at respective coordinates. The distance sensor 5 includes, for example, a stereoscopic image-type sensor, a pattern light radiation-type sensor, or a TOF (Time of Flight)-type sensor. Even if the distance sensor 5 is composed as any type of sensor, the distance sensor 5 includes an imaging element, and a lens which forms on the imaging element an image of light from a wider range than the view angle of the camera 4. The distance sensor 5 is attached to the frame 3 such that the imaging optical axis of the lens is opposed to the table 2. By this configuration, the distance sensor 5 acquires a distance image indicating a distance to the target on the table 2.

In the meantime, the camera 4 and distance sensor 5 may be constituted as one piece. For example, the camera 4 and distance sensor 5 may be configured such that the lens is shared, or may be configured such that the lens and imaging element are shared.

The information processing device 6 executes a commodity recognition process for recognizing a commodity disposed on the table 2, based on the image acquired by the camera 4. In addition, the information processing device 6 executes a commodity registration process for pre-registering an image of each of commodities for use in the commodity recognition process, based on the image acquired by the camera 4. As illustrated in FIG. 2, the information processing device 6 includes a display unit 11, an operation unit 12, an interface 13, an interface 14, a processor 15, a ROM 16, a RAM 17, a storage 18, and a time-measuring unit 19. The display unit 11, operation unit 12, interface 13, interface 14, processor 15, ROM 16, RAM 17, storage 18 and time-measuring unit 19 are interconnected via a bus 20 so as to be communicable with each other.

The display unit 11 displays a screen, based on the control of the processor 15. The display unit 11 includes a display panel, and a driving circuit which causes the display panel to display a screen. The display panel is, for example, a liquid crystal display, an organic EL display, or some other display for displaying a screen.

The operation unit 12 includes a plurality of operation members for a user to perform various operations of the commodity registration apparatus 1. The operation members are, for instance, a touch sensor, a keyboard, and number keys. The touch sensor is, for instance, a resistive-type touch sensor or a capacitive-type touch sensor. Specifically, the touch sensor acquires information indicative of a position designated in a certain area. The touch sensor and the display panel of the display unit 11 may integrally be constituted as a touch screen, and thereby a signal, which is indicative of a touched position on the display panel, may be input to the processor 15.

The interface 13 includes a terminal which is configured to be communicable with the camera 4. The interface 13 relays an input/output of data between the processor 15 and camera 4.

The interface 14 includes a terminal which is configured to be communicable with the distance sensor 5. The interface 14 relays an input/output of data between the processor 15 and distance sensor 5.

The processor 15 is an arithmetic element including a circuit for executing an arithmetic process. The processor 15 is, for instance, a CPU. The processor 15 executes various processes, based on programs stored in the ROM 16 or in the storage 18, and data which is used in the programs.

The ROM 16 is a nonvolatile memory which is exclusively used for a read operation. The ROM 16 stores programs, and data which is used in the programs. The ROM 16 is assembled in the information processing device 6 in the state in which programs according to the specifications of the commodity registration apparatus 1 and the data for use in the programs are stored in advance.

The RAM 17 is a volatile memory functioning as a working memory. The RAM 17 temporarily stores, for example, data which the processor 15 is processing. In addition, the RAM 17 temporarily stores a program which the processor 15 executes.

The storage 18 is a storage medium which can store various pieces of information. The storage 18 stores programs, and data for use in the programs. The storage 18 is, for instance, a solid-state drive (SSD), a hard-disk drive (HDD), or some other storage device. In addition, the storage 18 may be configured as a memory I/F, for instance, a card slot in which a storage medium such as a memory card is insertable.

The time-measuring unit 19 is a clock which measures an elapsed time.

The processor 15 functions as a processing unit which performs various controls for executing a commodity recognition process and a commodity registration process, by reading out and executing the programs and the data for use in the programs, which are stored, for example, in the ROM 16 or storage 18. For example, the processor 15 functions as an image acquisition unit, a timing controller, an image analysis unit, a dictionary registration unit, an alert processor, a flag switching unit, a mask processor, and a recognition processor.

The image acquisition unit executes acquisition of an image by the camera 4. The image acquisition unit sends a control signal for execution of photography to the camera 4, thereby controlling acquisition of an image by the camera 4. In addition, the image acquisition unit executes acquisition of a distance image by the distance sensor 5. The image acquisition unit sends a control signal for execution of photography to the distance sensor 5, thereby controlling acquisition of a distance image by the distance sensor 5.

The timing controller controls the timing of image acquisition by the image acquisition unit, in accordance with an elapsed time counted by the time-measuring unit 19. Specifically, the timing controller controls the image acquisition unit so that images are acquired by the image acquisition unit at preset regular time intervals.

The image analysis unit performs an analysis of an acquired image. For example, the image analysis unit extracts an area of each of objects appearing on an image acquired by the camera 4. The image analysis unit extracts an area where a commodity is assumed to appear, from the image acquired by the camera 4.

For example, the image analysis unit determines whether an area, which is not the table 2, is included in the image acquired by the camera 4. Specifically, the image analysis unit excludes an area of the same color as the color (black) of the table 2, from the image acquired by the camera 4, thereby determining whether an object other than the table 2 appears on the image. In other words, the image analysis unit extracts an area where the table 2 appears, as a background area, from the image acquired by the camera 4, and determines whether an area other than the background is included in the image. In addition, the image analysis unit may be configured to extract the background area in the image acquired by the camera 4, based on the distance image acquired by the distance sensor 5 and the image acquired by the camera 4. In this case, the image analysis unit recognizes, based on the distance image, a height at each of coordinates on the image acquired by the camera 4. Since the height of the table 2 is already known, the image analysis unit sets the height of the table 2 as a reference (e.g. 0), and extracts an area with no height as a background area from the image acquired by the camera 4.

In addition, for example, the image analysis unit extracts an image area of a part of a person from the image acquired by the camera 4. Specifically, the image analysis unit extracts an area (hand/arm area) where a hand or arm of a person appears, from the image acquired by the camera 4. For example, the image analysis unit determines whether an area of, for example, a flesh color is included in the image acquired by the camera 4. Specifically, the image analysis unit extracts, as a hand/arm area, an area of a flesh color which extends from an edge of the image acquired by the camera 4. In addition, the image analysis unit may be configured to extract a hand/arm area in the image acquired by the camera 4, based on the distance image acquired by the distance sensor 5 and the image acquired by the camera 4. In this case, the image analysis unit recognizes, based on the distance image, a height at each of coordinates on the image acquired by the camera 4. The image analysis unit compares the heights of adjacent pixels of the image, associates pixels with a difference in height of less than a preset threshold, and recognizes the associated pixels as one area. The image analysis unit extracts, as a hand/arm area, an area with a height which extends from an edge of the image acquired by the camera 4. In the meantime, the image analysis unit may be configured to extract, aside from the hand or arm of a person, an area in which an object, which is not suitable for registration of an image of a commodity, appears. In this case, too, the image analysis unit extracts an area with a height which extends from an edge of the image acquired by the camera 4, as an area in which an object, which is not suitable for registration of an image of a commodity, appears.

Furthermore, the image acquisition unit can cyclically acquire images by the camera 4 as a moving picture. In this case, the image analysis unit successively stores acquired images in a buffer memory such as the RAM 17. Thereby, the image analysis unit can compare, when an image was acquired by the camera 4, this image with the image acquired by the camera 4 in the past. Hence, the image analysis unit determines whether there is a variation between the images acquired by the camera 4, by comparing a previous frame (first image) and the present frame (second image). Specifically, the image analysis unit calculates a degree of similarity between the first image and the second image, and determines that there is a variation between the first image and second image, if the calculated degree of similarity is less than a preset threshold. Incidentally, the first image may be a composite of images of a plurality of frames which were acquired in the past. In addition, the comparison between the first image and second image by the image analysis unit may be executed, for example, by such a configuration that the image is divided into a plurality of blocks and a motion vector is detected in units of a block, or by such a configuration that matching of characteristic points is performed.

Furthermore, the image analysis unit stores in the buffer memory, such as the RAM 17, information (background area information) indicative of a range of a background area on the image, and information (hand/arm area information) indicative of a range of a hand/arm area. Thereby, the image analysis unit can recognize the range of the hand/arm area in the past. Based on the background area information and hand/arm area information stored in the RAM 17, the image analysis unit recognizes a transition from the state in which a hand holds a commodity to the state in which the hand releases the commodity. For example, the image analysis unit recognizes the state in which the hand holds the commodity and the state in which the hand releases the commodity, based on the relationship between the position of the hand/arm area and the position of the area that is not the table 2, which were recognized by the above process. Specifically, the image analysis unit recognizes that the hand holds the commodity, when the hand/arm area neighbors the area that is not the table 2, and recognizes that the hand releases the commodity, when the hand/arm area is apart from the area that is not the table 2. In other words, the image analysis unit determines that the hand released the commodity, when the state in which the hand/arm area neighbors the area that is not the table 2 transitioned to the state in which the hand/arm area is apart from the area that is not the table 2.

The dictionary registration unit registers, as a dictionary, an image on which a commodity is assumed to appear by the image analysis unit. In addition, the dictionary registration unit may register, as a dictionary, an image of an area on which a commodity is assumed to appear. The dictionary is, for example, information in which commodity information, such as a commodity name and a price, and an image are associated. Incidentally, the dictionary includes images of six faces of each of commodities. The dictionary registration unit stores the dictionary, for example, in the storage 18. In the meantime, the dictionary registration unit may be configured not to register an image itself as a dictionary, but to calculate a characteristic amount from an image and to register the calculated characteristic amount as a dictionary. In addition, the dictionary registration unit may be configured to register a local characteristic amount, which was extracted from an image, as a dictionary. Besides, the commodity registration apparatus 1 may be configured to generate commodity information, based on an operation input by the operation unit 12, or may be configured to receive commodity information from an external device via a communication unit (not shown) for communicating with the external device, or may be configured to read out commodity information from a storage medium via a memory I/F (not shown) to which a storage medium such as a memory card is connected.

The alert processor executes alert display by the display unit 11, when an image acquired by the camera 4 is an image which is not suitable for registration as a dictionary. In the meantime, when the commodity registration apparatus 1 includes a speaker, such a configuration may be adopted that alarm sound is produced by the speaker.

The flag switching unit switches ON/OFF of a flag which indicates whether or not to execute dictionary registration of an image acquired by the camera 4. The flag is stored, for example, in the RAM 17. The flag switching unit switches ON/OFF of the flag, based on an analysis result by the image analysis unit.

The mask processor executes a mask process for setting an area (exception area), which is not a target of dictionary registration, in the image acquired by the camera 4. Based on an analysis result by the image analysis unit, the mask processor sets, as exception areas, the background area in which the table 2 appears and the hand/arm area in the image acquired by the camera 4. In this case, the dictionary registration unit registers, as a dictionary, an image of an area, where the exception area is not set, in the image acquired by the camera 4.

The recognition processor compares the image acquired by the camera 4 and the image registered as the dictionary, thereby recognizing the commodity placed on the table 2. Specifically, the recognition processor calculates the degree of similarity between the image acquired by the camera 4 and the image registered as the dictionary. The recognition processor extracts from the dictionary the commodity information of the commodity with the highest calculated degree of similarity, thereby recognizing the commodity. By the provision of this recognition processor, the commodity registration apparatus 1 functions also a commodity recognition apparatus.

Next, the commodity registration process of the commodity registration apparatus 1 according to each of embodiments will be described.

### First Embodiment

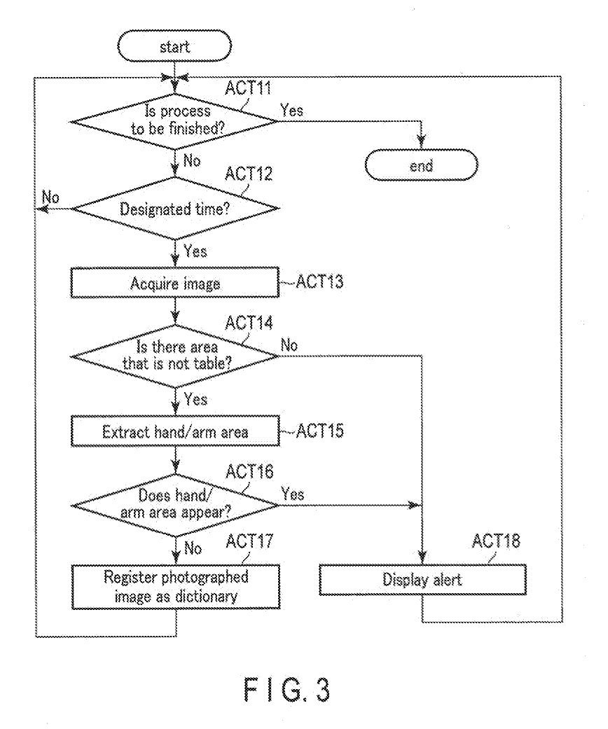

FIG. 3 is a flowchart for describing a commodity registration process of a commodity registration apparatus 1 according to a first embodiment.

As described above, at a time of executing the commodity registration process for creating a dictionary, it is necessary to acquire images of six faces of a commodity. In the present embodiment, in order to efficiently acquire images of plural faces of a commodity, the commodity registration apparatus 1 acquires images by the camera 4 at regular time intervals (e.g. intervals of five seconds), thereby acquiring images which can be registered as a dictionary. According to this configuration, photography is executed at regular time intervals, while the operator (user) of the commodity registration apparatus 1 is varying the direction of the commodity during photography. However, it is assumed that the user's hand or arm appears on the image, or the setting of the commodity fails to be in time for photography. Thus, the commodity registration apparatus 1 determines whether the image acquired by the camera 4 is an image which can be registered as a dictionary.

The processor 15 determines whether or not to finish the process (ACT 11). For example, when a preset number of images were registered as the dictionary, or when an instruction to finish the process was input by the operation unit 12 or the like, the processor 15 determines that the process is to be finished. If the processor 15 determines that the process is to be finished (ACT 11, YES), the processor 15 finishes the commodity registration process.

If the processor 15 determines that the process is not to be finished (ACT 11, NO), the processor 15 determines whether a designated time has come or not (ACT 12). If the processor 15 determines that the designated time has not come (ACT 12, NO), the processor 15 returns to the process of ACT 11. If the processor 15 determines that the designated time has come (ACT 12, YES), the processor 15 acquires an image (ACT 13). Thereby, the commodity registration apparatus 1 acquires images by the camera 4 at regular time intervals.

The processor 15 determines whether an area that is not the table 2 is included in the image (ACT 14). For example, the processor 15 extracts a background area from the image, and determines whether an area other than the background is included in the image.

If the processor 15 determines that an area that is not the table 2 is included in the image (ACT 14, YES), the processor 15 extracts a hand/arm area from the image (ACT 15), and determines whether a hand/arm area is included in the image or not (ACT 16).

If the processor 15 determines that a hand/arm area is not included in the image (ACT 16, NO), the processor 15 registers the image acquired in ACT 13 as a dictionary (ACT 17), and returns to the process of ACT 11.

Besides, if the processor 15 determines in ACT 14 that an area that is not the table 2 is not included in the image (ACT 14, NO), or if the processor 15 determines in ACT 16 that a hand/arm area is included in the image (ACT 16, YES), the processor 15 executes alert display (ACT 18) and returns to the process of ACT 11. For example, the processor 15 executes alert display for prompting re-execution of photography.

According to the above-described first embodiment, the commodity registration apparatus 1 executes photography at regular time intervals, and registers an acquired image as a dictionary if a hand/arm area is not included in the acquired image and if an area other than the background is included in the image. By this configuration, the commodity registration apparatus 1 can prevent an image, in which a hand/arm area is included or in which no commodity appears, from being registered as a dictionary, and can efficiently register images of plural faces of the commodity as a dictionary.

### Second Embodiment

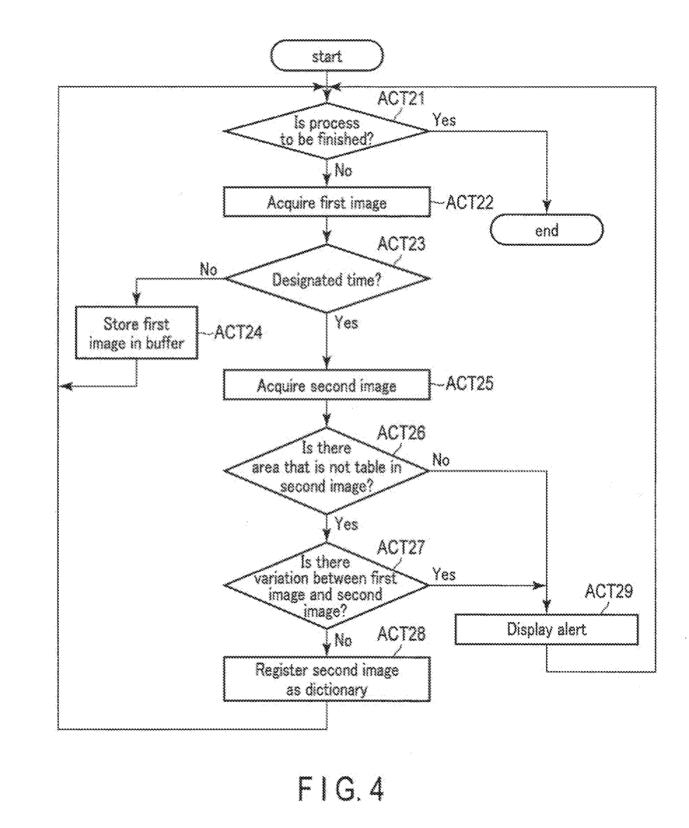

FIG. 4 is a flowchart for describing a commodity registration process of a commodity registration apparatus 1 according to a second embodiment. The commodity registration apparatus 1 according to the second embodiment cyclically captures images by the camera 4, compares a previous frame (first image) and the present frame (second image), and determines that the image acquired by the camera 4 is an image which is registrable as a dictionary, if there is no variable between the previous frame (first image) and the present frame (second image).

The processor 15 determines whether or not to finish the process (ACT 21). If the processor 15 determines that the process is to be finished (ACT 21, YES), the processor 15 finishes the commodity registration process.

If the processor 15 determines that the process is not to be finished (ACT 21, NO), the processor 15 acquires a first image (ACT 22).

The processor 15 determines whether a designated time has come or not (ACT 23).

If the processor 15 determines that the designated time has not come (ACT 23, NO), the processor 15 stores the first image, which was acquired in ACT 22, in the buffer memory such as the RAM 17 (ACT 24), and returns to the process of ACT 21. The processor 15 cyclically acquires first images by repeatedly executing the process of ACT 21 to ACT 24.

If the processor 15 determines in ACT 23 that the designated time has come (ACT 23, YES), the processor 15 acquires a second image (ACT 25).

The processor 15 determines whether an area that is not the table 2 is included in the second image (ACT 26).

If the processor 15 determines that an area that is not the table 2 is included in the second image (ACT 26, YES), the processor 15 compares the second image and the first image, and determines whether there is a variation (difference) between the second image and the first image (ACT 27).

If the processor 15 determines that there is no variation between the second image and the first image (ACT 27, NO), the processor 15 registers the second image as a dictionary (ACT 28) and returns to the process of ACT 21.

In addition, if the processor 15 determines in ACT 26 that an area that is not the table 2 is not included in the second image (ACT 26, NO), or if the processor 15 determines in ACT 27 that there is a variation between the second image and the first image (ACT 27, YES), the processor 15 executes alert display (ACT 29) and returns to the process of ACT 21. For example, if the processor 15 determines that there is a variation between the first image and second image, the processor 15 executes alert display for prompting re-execution of photography.

According to the above-described second embodiment, the commodity registration apparatus 1 successively acquires first images, and acquires second images at regular time intervals. If there is no variation between the acquired first image and second image and if an area other than the background is included in the second image, the commodity registration apparatus 1 registers the second image as a dictionary. By this configuration, the commodity registration apparatus 1 can register as the dictionary the second image which was acquired in the state in which the commodity is at rest. Specifically, the commodity registration apparatus 1 can prevent an image, which was acquired in the state in which the commodity is not at rest, from being registered as a dictionary, and can efficiently register images of plural faces of the commodity as a dictionary.

In the meantime, the commodity registration apparatus 1 may be configured such that the determination result as to whether the hand/arm area was extracted or not, as illustrated in the first embodiment, is also used for the determination as to whether the image is registered as the dictionary.

### Third Embodiment

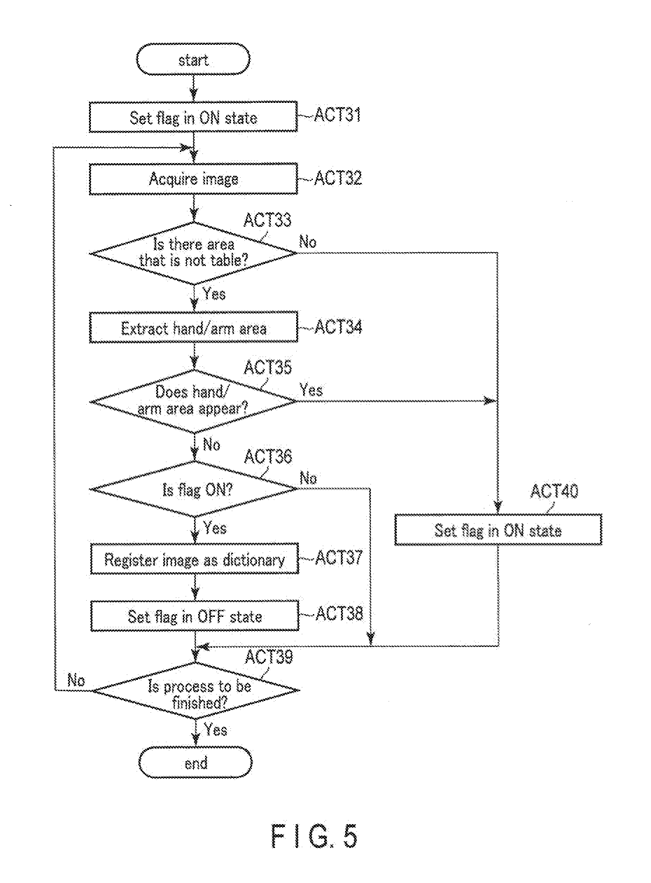

FIG. 5 is a flowchart for describing a commodity registration process of a commodity registration apparatus 1 according to a third embodiment. The commodity registration apparatus 1 according to the third embodiment cyclically captures images by the camera 4, and executes dictionary registration of the image, with the execution of a predetermined action being used as a trigger. Specifically, when it was detected that a hand supporting a commodity disappeared from the view angle, the commodity registration apparatus 1 acquires an image by the camera 4 and registered the acquired image as a dictionary. For this purpose, the commodity registration apparatus 1 controls the commodity registration process by switching the above-described flag, based on the image.

The processor 15 sets the flag in an ON state (ACT 31).

The processor 15 acquires an image (ACT 32).

The processor 15 determines whether an area that is not the table 2 is included in the image acquired in ACT 32 (ACT 33).

If the processor 15 determines that an area that is not the table 2 is included in the image (ACT 33, YES), the processor 15 extracts a hand/arm area from the image (ACT 34), and determines whether a hand/arm area is included in the image or not (ACT 35).

If the processor 15 determines that a hand/arm area is not included in the image (ACT 35, NO), the processor 15 determines whether the flag is ON or not (ACT 36).

If the processor 15 determines that the flag is ON (ACT 36, YES), the processor 15 registers the image, which was acquired in ACT 32, as a dictionary (ACT 37).

The processor 15 sets the flag in an OFF state (ACT 38).

The processor 15 determines whether or not to finish the process (ACT 39). If the processor 15 determines that the process is to be finished (ACT 39, YES), the processor 15 finishes the commodity registration process.

If the processor 15 determines that the process is not to be finished (ACT 39, NO), the processor 15 returns to the process of ACT 32.

In addition, if the processor 15 determines in ACT 36 that the flag is not ON (ACT 36, NO), the processor 15 goes to the process of ACT 39.

Besides, if the processor 15 determines in ACT 33 that an area that is not the table 2 is not included in the image (ACT 33, NO), or determines in ACT 35 that a hand/arm area is included in the image (ACT 35, YES), the processor 15 sets the flag in the ON state (ACT 40), and goes to the process of ACT 39.

According to the above-described third embodiment, if an area that is not the table 2 is not included in the image or if a hand/arm area is included in the image, the commodity registration apparatus 1 estimates that the direction of the commodity is being changed, and sets the flag in the ON state or keeps the flag in the ON state. In the state in which the flag is ON, if it is detected that an area that is not the table 2 is included in the image and that a hand/arm area is not included in the image, the commodity registration apparatus 1 determines that the changing of the direction of the commodity was completed, and registers the image as the dictionary. By this configuration, the commodity registration apparatus 1 can prevent an image in which the hand/arm area is included, or an image in the state in which the changing of the direction of the commodity is not completed or in which the commodity does not appear, from being registered as a dictionary, and can efficiently register images of plural faces of the commodity as a dictionary. Furthermore, since the commodity registration apparatus 1 is configured such that the flag is set in the OFF state after the image was registered as the dictionary, it is possible to prevent plural images in the same state from being registered.

In the meantime, the commodity registration apparatus 1 may be configured such that the comparison result between the previous frame image and the present frame image, as illustrated in the second embodiment, is also used for the determination as to whether or not to execute the process of ACT 37.

### Fourth Embodiment

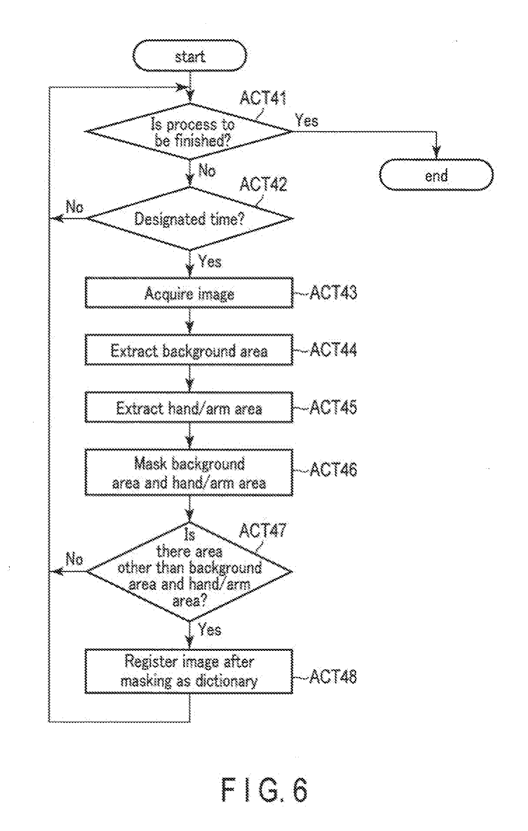

FIG. 6 is a flowchart for describing a commodity registration process of a commodity registration apparatus 1 according to a fourth embodiment. The commodity registration apparatus 1 according to the fourth embodiment cyclically captures images by the camera 4, detects a background area and a hand/arm area from the acquired image, and registers an image, from which the detected background area and hand/arm area are excluded, as a dictionary.

The processor 15 determines whether or not to finish the process (ACT 41). If the processor 15 determines that the process is to be finished (ACT 41, YES), the processor 15 finishes the commodity registration process.

If the processor 15 determines that the process is not to be finished (ACT 41, NO), the processor 15 determines whether a designated time has come or not (ACT 42).

If the processor 15 determines that the designated time has not come (ACT 42, NO), the processor 15 returns to the process of ACT 41.

If the processor 15 determines that the designated time has come (ACT 42, YES), the processor 15 acquires an image (ACT 43).

The processor 15 extracts a background area from the image (ACT 44).

The processor 15 extracts a hand/arm area from the image (ACT 45).

The processor 15 executes a mask process on the background area and hand/arm area in the image (ACT 46). The mask process is, concretely, a process of selecting an area. Specifically, the processor 15 selects an area of the image acquired in ACT 43, from which the background area and hand/arm area are excluded, as an image which is to be registered as a dictionary.

The processor 15 determines whether an area other than the background area and hand/arm area is included in the image that was subjected to the mask process (ACT 47). If the processor 15 determines that an area other than the background area and hand/arm area is not included (ACT 47, NO), the processor 15 returns to the process of ACT 41.

If the processor 15 determines that an area other than the background area and hand/arm area is included (ACT 47, YES), the processor 15 registers the image, which was subjected to the mask process, as a dictionary (ACT 48), and returns to the process of ACT 41.

According to the above-described fourth embodiment, the commodity registration apparatus 1 extracts a background area and a hand/arm area from the image acquired by the camera 4, and sets the extracted background area and hand/arm area as an exception area. If the commodity registration apparatus 1 determines that an area other than the exception area is included in the image acquired by the camera 4, the commodity registration apparatus 1 registers, as a dictionary, an image obtained by excluding the background area and hand/arm area from the image acquired by the camera 4. By this configuration, the commodity registration apparatus 1 can prevent an image in which the hand/arm area is included, or an image in the state in which the commodity does not appear, from being registered as a dictionary, and can efficiently register images of plural faces of the commodity as a dictionary. Furthermore, according to this configuration, since the commodity registration apparatus 1 can execute dictionary registration even when the hand is within the view angle of the camera 4, the time and labor of the user for the dictionary registration can be reduced.

In the meantime, the commodity registration apparatus 1 may be configured such that the comparison result between the previous frame image and the present frame image, as illustrated in the second embodiment, is also used for the determination as to whether or not to execute the process of ACT 48.

In the present embodiment, the configuration was described in which the hand/arm area is extracted based on the image acquired by the camera 4 and/or the distance image acquired by the distance sensor 5. The embodiment, however, is not limited to this configuration. The commodity registration apparatus 1 may be configured to include, for example, a thermosensor which senses temperatures, and to extract a hand/arm area in the image acquired by the camera 4, based on a sensed result of the thermosensor.

### Fifth Embodiment

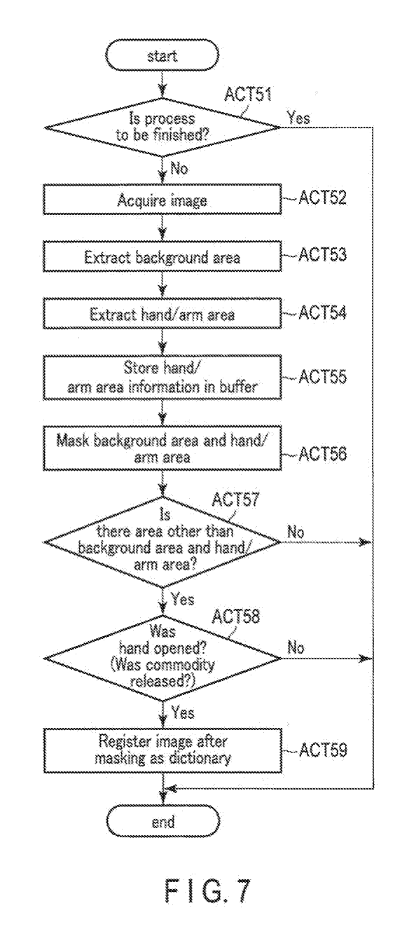

FIG. 7 is a flowchart for describing a commodity registration process of a commodity registration apparatus 1 according to a fifth embodiment. The commodity registration apparatus 1 according to the fifth embodiment cyclically captures images by the camera 4, executes a mask process on the image, with the execution of a predetermined action being used as a trigger, and registers the image, which was subjected to the mask process, as a dictionary. Specifically, the commodity registration apparatus 1 executes a mask process of setting a background area and a hand/arm area on the image as an exception area, when the state in which a commodity is held by the hand has transitioned to the state in which the commodity is released, and registers the image, from which the exception area was excluded, as a dictionary.

The processor 15 determines whether or not to finish the process (ACT 51). If the processor 15 determines that the process is to be finished (ACT 51, YES), the processor 15 finishes the commodity registration process.

If the processor 15 determines that the process is not to be finished (ACT 51, NO), the processor 15 acquires an image (ACT 52).

The processor 15 extracts a background area from the image (ACT 53).

The processor 15 extracts a hand/arm area from the image (ACT 54).

The processor 15 stores background area information and hand/arm area information in the buffer (ACT 55).

The processor 15 executes a mask process on the background area and hand/arm area in the image (ACT 56).

The processor 15 determines whether an area other than the background area and hand/arm area is included in the image that was subjected to the mask process (ACT 57).

If the processor 15 determines that an area other than the background area and hand/arm area is included (ACT 57, YES), the processor 15 determines whether the hand released the commodity (ACT 58).

If the processor 15 determines that the hand released the commodity (ACT 58, YES), the processor 15 registers the image, which was subjected to the mask process, as a dictionary (ACT 59), and returns to the process of ACT 51.

If the processor 15 determines in ACT 57 that an area other than the background area and hand/arm area is not included (ACT 57, NO), or if the processor 15 determines that the hand does not release the commodity (ACT 58, NO), the processor 15 returns to the process of ACT 51.

According to the above-described fifth embodiment, the commodity registration apparatus 1 stores the background area information and hand/arm area information in the RAM 17 or the like, and recognizes the positional relationship between the area of the image, where the commodity is assumed to appear, and the hand/arm area, thereby recognizing the state in which the hand holds the commodity and the state in which the hand is apart from the commodity. When the state in which the hand holds the commodity has changed to the state in which the hand is apart from the commodity, the commodity registration apparatus 1 registers the image, which was subjected to the mask process, as a dictionary. By this configuration, the commodity registration apparatus 1 can prevent an image in which the hand/arm area is included, or an image in the state in which the commodity does not appear, from being registered as a dictionary, and can efficiently register images of plural faces of the commodity as a dictionary. Furthermore, according to this configuration, since the commodity registration apparatus 1 can execute dictionary registration even when the hand is within the view angle of the camera 4, the time and labor of the user for the dictionary registration can be reduced.

In the meantime, the commodity registration apparatus 1 may be configured such that the comparison result between the previous frame image and the present frame image, as illustrated in the second embodiment, is also used for the determination as to whether or not to execute the process of ACT 59.

In the above-described FIG. 3 to FIG. 7, the processes in the case where the commodity registration apparatus 1 executes the commodity registration process were described. However, the commodity registration apparatus 1 may be configured to execute the processes illustrated in FIG. 3 to FIG. 7 when the commodity registration apparatus 1 executes the commodity recognition process. Specifically, the commodity registration apparatus 1 is not restricted to the configuration in which the commodity registration apparatus 1 determines whether or not to execute dictionary registration, based on the processing results illustrated in FIG. 3 to FIG. 7. The commodity registration apparatus 1 may be configured to determine whether or not to execute the commodity recognition process, based on the processing results illustrated in FIG. 3 to FIG. 7.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A commodity registration apparatus comprising:
an interface configured to acquire an image on which a commodity appears; and
a processor configured to:
extract a hand/arm area which is an image area of a part of a person in the image;
output an alert when the hand/arm area was extracted; and
register, as a dictionary, the image acquired by the interface, when the hand/arm area is not extracted.

2. The commodity registration apparatus of claim 1, wherein the interface is configured to cyclically acquire images,
the processor is configured to:
compare, and determine presence/absence of a variation between, the image acquired by the interface, and an image acquired by the interface in a past;
output the alert when the processor determined the presence of the variation; and
register, as the dictionary, the image acquired by the interface, when the processor determined the absence of the variation and determined absence of the hand/arm area.

3. The commodity registration apparatus of claim 1, wherein the interface is configured to cyclically acquire images, and
the processor is configured to register, as the dictionary, the image acquired by the interface, when a transition occurred from a state in which the hand/arm area is extracted to a state in which the hand/arm area is not extracted by the image analysis unit.

4. The commodity registration apparatus of claim 3, wherein the processor is configured to:
compare, and determine presence/absence of a variation between, the image acquired by the interface, and an image acquired by the interface in a past;
output the alert when the processor determined the presence of the variation; and
register, as the dictionary, the image acquired by the interface, when the transition occurred from the state in which the hand/arm area is extracted to the state in which the hand/arm area is not extracted and the processor determined the absence of the variation in the image acquired by the interface.

5. The commodity registration apparatus of claim 1, wherein the interface is configured to acquire an image from a camera configured to cyclically photograph a commodity placed on a table,
the processor is configured to:
extract, from the image, the hand/arm area and a background area on which the table appears, and to recognize execution of a predetermined action by a hand, based on a position of the hand/arm area and a position of the background area;
exclude the hand/arm area and the background area which were extracted, from the image acquired by the interface; and
register, as the dictionary, an image from which the hand/arm area and the background area are excluded, when the processor recognized the execution of the predetermined action by the hand.

6. The commodity registration apparatus of claim 5, wherein the processor is configured to:
recognize, based on the position of the hand/arm area and the position of the background area, a state in which the hand holds the commodity and a state in which the hand releases the commodity; and
register, as the dictionary, the image from which the hand/arm area and the background area are excluded, when a transition occurred from the state in which the hand holds the commodity to the state in which the hand releases the commodity.

7. The commodity registration apparatus of claim 6, wherein the processor is configured to:
compare, and determine presence/absence of a variation between, the image acquired by the interface, and an image acquired by the interface in a past;
output the alert when the processor determined the presence of the variation; and
register, as the dictionary, the image from which the hand/arm area and the background area are excluded, when the transition occurred from the state in which the hand holds the commodity to the state in which the hand releases the commodity, and when the processor determined the absence of the variation.

8. A commodity registration apparatus comprising:
an interface configured to acquire an image from a camera configured to photograph a commodity placed on a table; and
a processor configured to:
extract, from the image, a hand/arm area which is an image area of a part of a person, and a background area on which the table appears;
exclude the hand/arm area and the background area which were extracted, from the image acquired by the interface; and
register, as a dictionary, an image from which the hand/arm area and the background area are excluded.

9. The commodity registration apparatus of claim 8, wherein the interface is configured to cyclically acquire images,
the processor is configured to:
compare, and determine presence/absence of a variation between, the image acquired by the interface, and an image acquired by the interface in a past; and
register, as the dictionary, an image obtained by excluding, from the image acquired by the interface, the hand/arm area and the background area extracted when the processor determined the absence of the variation.

10. A commodity registration method comprising:
acquiring an image on which a commodity appears;
extracting a hand/arm area which is an image area of a part of a person in the acquired image;
outputting an alert when the hand/arm area was extracted; and
registering, as a dictionary, the image, when the hand/arm area is not extracted.
